(19) United States
(12) Patent Application Publication
(10) Pub. No.: US 2013/0155235 A1
(43) Pub. Date: Jun. 20, 2013

(54) IMAGE PROCESSING METHOD

(71) Applicants: Stuart Clough, Cheshire (GB); Keith Hendry, Cheshire (GB); Adrian Williams, Manchester (GB)

(72) Inventors: Stuart Clough, Cheshire (GB); Keith Hendry, Cheshire (GB); Adrian Williams, Manchester (GB)

(73) Assignee: APEM Limited, Stockport (GB)

(21) Appl. No.: 13/438,106

(22) Filed: Apr. 3, 2012

(30) Foreign Application Priority Data
Dec. 17, 2011 (GB) 1121815.3

(51) Int. Cl. G06K 9/00; H04N 7/18

(52) U.S. Cl. 348/144; 382/110; 348/E07.085

(57) ABSTRACT

A computer implemented method for distinguishing between animals depicted in one or more images, based upon one or more taxonomic groups. The method comprises receiving image data comprising a plurality of parts, each part depicting a respective animal, determining one or more spectral properties of at least some pixels of each of the plurality of parts, and allocating each of the plurality parts to one of a plurality of sets based on the determined spectral properties, such that animals depicted in parts allocated to one set belong to a different taxonomic group than animals depicted in parts allocated to a different set.

### RELATED APPLICATIONS

This application claims priority to United Kingdom Patent Application No. 1121815.3, filed on Dec. 17, 2011.

### SUMMARY

The present invention is concerned with methods and systems for distinguishing between animals depicted in one or more images based on one or more taxonomic groups and is particularly, but not exclusively, applicable to processing images of birds.

Increasing awareness of environmental issues and a general desire to preserve biodiversity mean that institutions are commonly required to undertake environmental impact assessment (EIA) wildlife surveys for certain types of infrastructure projects. Generally, the aim of such surveys is to indentify, quantify and monitor over time the wildlife within the area being developed. Preferably, wildlife surveys are performed before, during and after the lifetime of the construction phase of an infrastructure project to more fully understand the environmental impact of the infrastructure project on local wildlife over time. In addition to infrastructure project EIAs, wildlife surveys may be performed for many other reasons, such as the collection of wildlife census data (e.g. for use in culling programmes).

Avian surveys are of particular importance for infrastructure construction projects such as wind turbines. For such surveys it is generally necessary to quantify the levels of one or more particular birds of interest (for example endangered species). Avian surveys have traditionally been performed by flying an aircraft over a survey area so that one or more personnel (known as “spotters”), equipped with binoculars, can manually scan an area (generally between set look angles perpendicular from the aircraft flight direction of between sixty-five and eighty-five degrees from vertical) and record the number and type of birds observed, often using a dictation machine. Generally, the flight altitude of a survey aircraft is seventy-six metres (two-hundred-fifty feet).

Such a method of performing surveys has many drawbacks. In particular, the method relies upon the ability of each spotter to identify the type of bird observed, (when counting) when flying at speed. This is challenging even for a trained ornithologist, particularly given that some species of birds are visually very similar, but is even more difficult when required to speciate bird groups. For example, it can be difficult to distinguish between razorbills and guillemots (both members of the auk group), especially when trying to do so from height and at speed. As such, the results of such surveys are generally inaccurate and unrepeatable (and hence unverifiable) by an independent body and are therefore of questionable value.

In many cases, if a particular type of a bird cannot be determined, it may be necessary to assume the “worst case”. For example, if a bird may belong to one of two species, and one of those species is protected, it may be necessary to assume that the bird belongs to the protected species. An inability to accurately identify observed bird species may, therefore, prejudice, or prevent, a planned construction project unnecessarily.

Hence there is a need for robust and accurate methods and systems for performing avian surveys.

It is an object of the present invention to obviate or mitigate the problems outlined above.

According to a first aspect of the present invention, there is provided a computer implemented method for distinguishing between animals depicted in one or more images based upon one or more taxonomic groups, comprising: receiving image data comprising a plurality of parts, each part depicting a respective animal; determining one or more spectral properties of at least some pixels of each of said plurality of parts; allocating each of said plurality parts to one of a plurality of sets based on said determined spectral properties; such that animals depicted in parts allocated to one set belong to a different taxonomic group than animals depicted in parts allocated to a different set.

The first aspect therefore automatically determines, based on spectral properties of the image data, whether animals depicted in different parts of the received image data belong to the same taxonomic group. By allocating parts of the image data depicting animals of different taxonomic groups to different sets, the identification of large numbers of animals is therefore facilitated by the first aspect of the invention.

Determining one or more spectral properties may comprise comparing spectral histogram data generated for the at least some pixels of each part.

Comparing spectral histogram data may comprise comparing locations of peaks in respective spectral histogram data generated for the at least some pixels of each part of said image data.

Allocating each of the plurality of parts to one of a plurality of sets may comprise applying a k-means clustering algorithm on the spectral properties of the at least some pixels of each part.

The method may further comprise processing the received image data to identify at least one of the parts of the image data depicting an animal.

The image data may be colour image data and identifying a part of the image data may comprise processing the image data to generate a greyscale image and identifying at least a part of the greyscale image depicting an animal.

Identifying a part of the image data may comprise applying an edge detection operation to image data to generate a first binary image.

The edge detection may comprise convolving the image data with a Gaussian function having a standard deviation of less than 2. The Gaussian function may have a standard deviation of approximately 0.5. For example, the standard deviation may be from about 0.45 to 0.55.

The method may further comprise applying a dilation operation to the first binary image using a predetermined structuring element.

The method may further comprise applying a fill operation to the first binary image.

The method may further comprise applying an erosion operation to the first binary image.

Identifying a part of the image data may comprise applying a thresholding operation to the image data to generate a second binary image.

The method may further comprise combining the first and second binary images with a logical OR operation to generate a third binary image.

The edge detection may comprise Canny edge detection and may use a strong edge threshold greater than about 0.4. For example, the strong edge threshold may be from about 0.45 to 0.55. For example, the strong edge threshold may be approximately 0.5.

The method may further comprise manually labelling one or more animals in the image data with a first taxonomic group of a first taxonomic rank. Separating each of the plurality of images into sets may comprise separating each of the plurality of images into sets based upon a second taxonomic group of a second taxonomic rank, the second taxonomic rank being lower than the first taxonomic rank.

The method may further comprise identifying a first taxonomic group of animals depicted in parts of the image data separated into a first set based upon a known second taxonomic group of animals depicted in parts of the image data separated into a second set and outputting an indication of the first taxonomic group.

The animals may be birds. The animals may be birds belonging to the auk group. The animals may each be either a guillemot or a razorbill.

The image data may be image data that was acquired from a camera mounted aboard an aircraft, the camera being adapted to acquire images in a portion of the electromagnetic spectrum outside the visible spectrum.

The image data may be image data that was acquired by a camera adapted to acquire images in an infra-red portion of the electromagnetic spectrum.

The image data may be image data that was acquired of about 240 to 250 metres above sea level, and preferable from a height of about 245 metres above sea level.

The method may further comprise selecting one of the parts depicting an animal, identifying a third taxonomic group of the animal based on a set to which the animal has been allocated, determining a flight height of the animal depicted in the part based upon a known average size of the animal. The known average size may be based upon the third taxonomic group. That is, average sizes of animals belonging to different taxonomic groups may be stored such that, after determining a taxonomic group to which an animal belongs, an average size of that animal can be determined.

Calculating a flight height of the animal may comprise determining a ground sample distance of the image data, using the determined ground sample distance to determine an expected pixel size of an animal belonging to the third taxonomic group at a distance equal to a flight height of the aircraft, and determining the flight height of the animal based upon a difference between the expected size and a size of the depiction of the animal in the part of the image data.

The method may further comprise selecting one of the parts depicting an animal and determining a flight direction of the animal depicted in the part. Determining the flight direction may comprise receiving indication of a first pixel of the part and receiving an indication of a second pixel of the part, where one of the first or second pixels indicates a rearmost pixel of the animal and the other of the first or second pixels indicates a foremost pixel of the animal. Determining the flight direction may further comprise using quadrant trigonometry to calculate the direction of flight. The calculated direction of flight may be corrected using a direction of flight (heading) of the aircraft at the point of capture of the image data.

According to a second aspect of the present invention, there is provided a method of generating image data to be used in the first aspect of the present invention: comprising mounting a camera aboard an aircraft, the camera being adapted to capture images in a visible portion of the spectrum and in a non-visible portion of the spectrum; and capturing images of animals in a space below the aircraft.

The method may comprise flying the aircraft at a height of around 240 meters above sea level.

It will be appreciated that aspects of the present invention can be implemented in any convenient way including by way of suitable hardware and/or software. Alternatively, a programmable device may be programmed to implement embodiments of the invention. The invention therefore also provides suitable computer programs for implementing aspects of the invention. Such computer programs can be carried on suitable carrier media including tangible carrier media (e.g. hard disks, CD ROMs and so on) and intangible carrier media such as communications signals.

It will be appreciated that features presented in the context of one aspect of the invention in the preceding and following description can equally be applied to other aspects of the invention.

Embodiments of the invention are now described, by way of example, with reference to the accompanying drawings in which:

### BRIEF DESCRIPTION OF THE DRAWINGS

FIG. 1 is a schematic illustration of components of a system suitable for implementing embodiments of the present invention;

FIG. 2 is a flowchart showing processing carried out in some embodiments of the present invention to automatically differentiate between and to identify bird objects within image data;

FIG. 3 is a flowchart showing the processing of FIG. 2 to detect bird objects within image data in further detail;

FIG. 4 is a schematic illustration of images generated during the processing of FIG. 3;

FIG. 5 is an illustration of the effect of varying a sigma parameter of the Canny edge detection algorithm in the processing of FIG. 3;

FIG. 6 is an illustration of the effect of varying a threshold parameter of the Canny edge detection algorithm in the processing of FIG. 3;

FIG. 7 is an illustration of the effect of varying the size of a structuring element used for morphological dilation and erosion in the processing of FIG. 3;

FIG. 8 is a scatter plot showing the results of a cluster analysis performed in the processing of FIG. 3;

FIG. 9 shows spectral histograms generated during the processing of FIG. 3;

FIG. 10 is a flowchart showing processing performed in some embodiments of the present invention to automatically differentiate between bird objects identified by the processing of FIG. 3; and

FIG. 11 is a graph showing a correlation between actual distances of bird objects from a camera, and those calculated by way of embodiments of the present invention.

### DETAILED DESCRIPTION

Embodiments of the present invention are arranged to process images of birds in an area to be surveyed. While the images may be obtained using any appropriate means, in preferred embodiments of the present invention, suitable images are obtained using a camera adapted to capture high resolution images (preferably at least thirty megapixels) at varying aperture sizes and at fast shutter speeds (preferably greater than 1/1500 of a second).

To obtain images of an area to be surveyed, the camera is preferably mounted aboard an aircraft. Where the camera is to be mounted aboard an aircraft, the camera is preferably mounted by way of a gyro-stabilised mount to minimise the effects of yaw, pitch and roll of the aircraft. The aircraft is then flown over the area under survey and aerial images of the area obtained. It has been found that flying the aircraft at a minimum height of around 245 metres above sea-level allows for suitable images to be acquired. Dependant on lens fittings, the flight height of the aircraft could be higher.

Each image captured by the camera may be saved with metadata detailing the time and date at which that image was captured and the precise co-ordinates (in a geographic coordinate system) of the image centre, collected by a Global Positioning System antenna also mounted aboard the aircraft, and an inertial measurement unit which forms part of the gyro-stabilised mount.

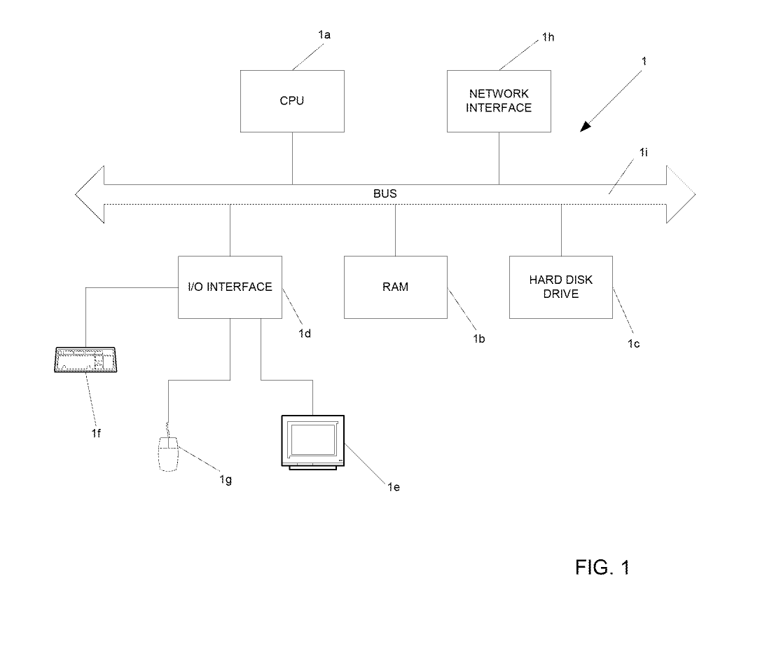

Referring to FIG. 1 there is shown a schematic illustration of components of a computer 1 which can be used to implement processing of the images in accordance with some embodiments of the present invention. It can be seen that the computer 1 comprises a CPU 1a which is configured to read and execute instructions stored in a volatile memory 1b which takes the form of a random access memory. The volatile memory 1b stores instructions for execution by the CPU 1a and data used by those instructions. For example, during processing, the images to be processed may be loaded into and stored in the volatile memory 1b.

The computer 1 further comprises non-volatile storage in the form of a hard disc drive 1c. The images and metadata to be processed may be stored on the hard disc drive 1c. The computer 1 further comprises an I/O interface 1d to which are connected peripheral devices used in connection with the computer 1. More particularly, a display 1e is configured so as to display output from the computer 1. The display 1e may, for example, display representations of the images being processed, together with tools that can be used by a user of the computer 1 to aid in the identification of bird types present in the images. Input devices are also connected to the I/O interface 1d. Such input devices include a keyboard 1f and a mouse 1g which allow user interaction with the computer 1. A network interface 1h allows the computer 1 to be connected to an appropriate computer network so as to receive and transmit data from and to other computing devices. The CPU 1a, volatile memory 1b, hard disc drive 1c, I/O interface 1d, and network interface 1h, are connected together by a bus 1i.

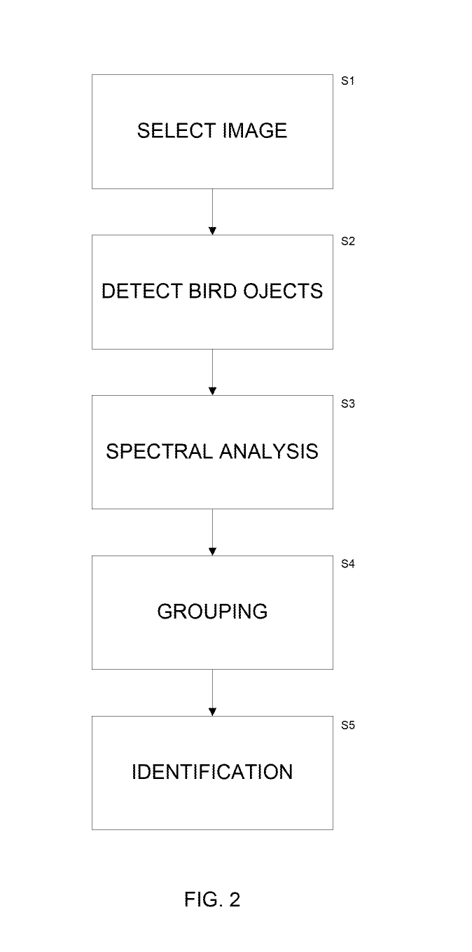

Processing performed in embodiments of the present invention to automatically differentiate between types of birds present in an image is now described with reference to FIG. 2. In the description below it is assumed that survey image data to be processed has been acquired using an aircraft-mounted camera system of the type described above.

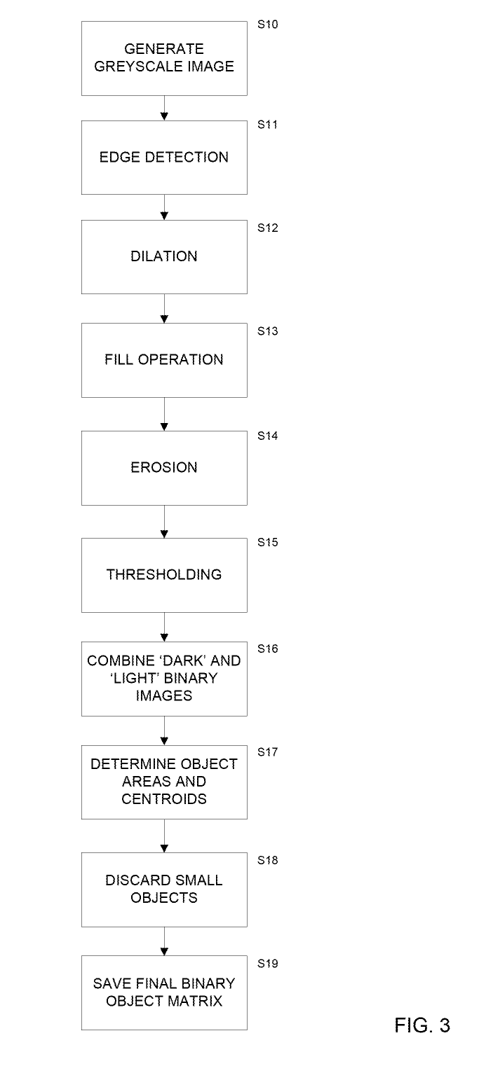

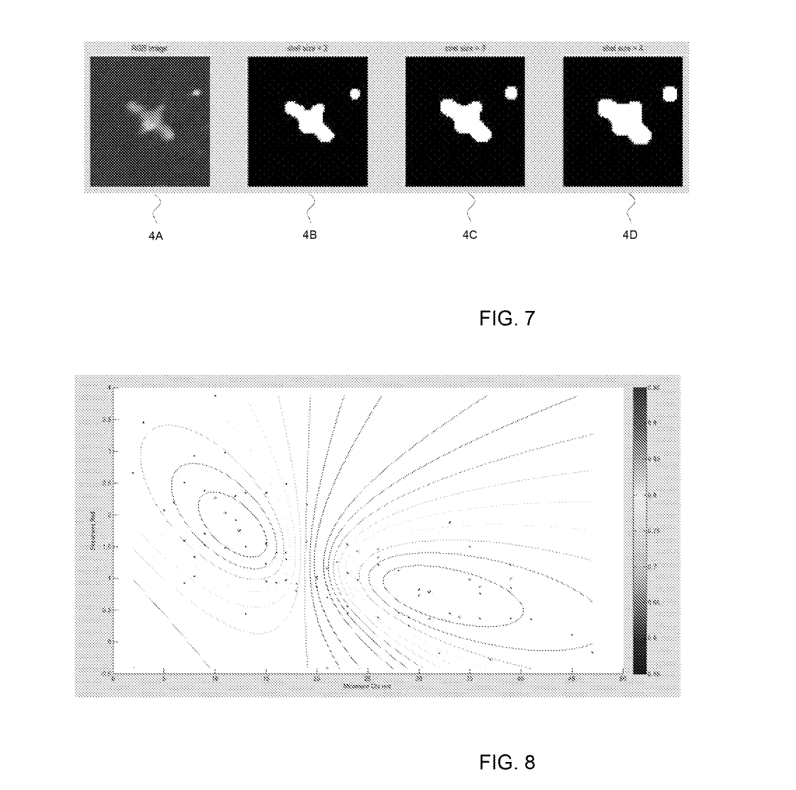

At a step S1, an image to be processed is selected. The image may be selected manually by a human user or may be selected automatically, for example as part of a batch processing operation. At a step S2, object recognition is used to identify parts of the image in which birds are depicted. The processing carried out to effect the object recognition is described in more detail below with reference to FIG. 3. Once each bird has been identified, processing passes to a step S3, at which, for each bird present in the selected image, pixels representing that bird are analysed to extract information about the spectral properties of the depicted bird. Processing then passes to a step S4, at which the determined spectral property information is processed to group each bird into one of a plurality of groups, each group sharing similar spectral properties. This grouping information is then used, at a step S5, to aid determination of the types of the birds in the selected image. The processing of steps S3 to S5 is described in more detail below with reference to FIG. 7.

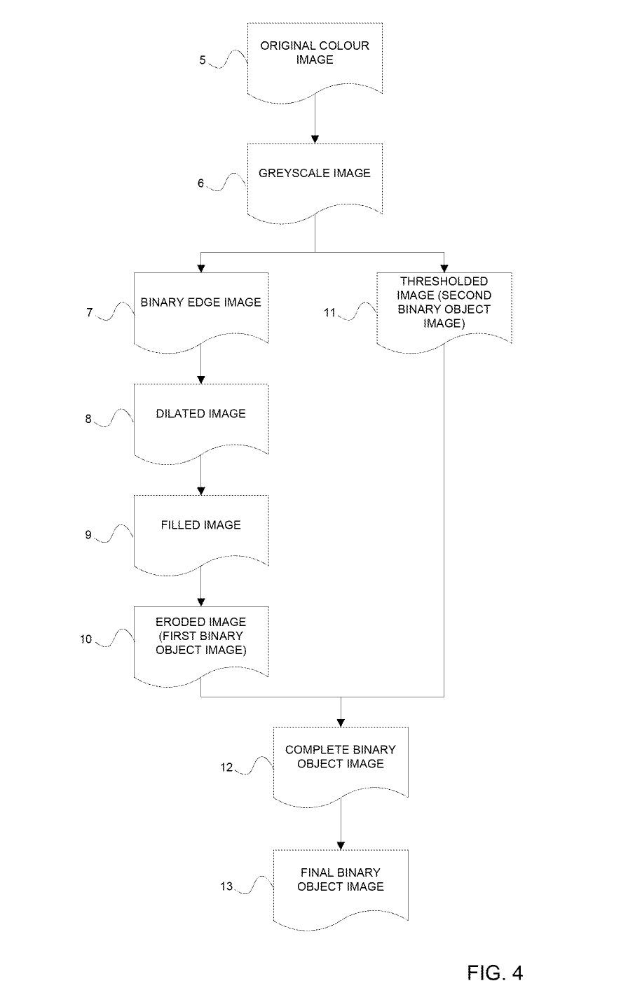

An example of processing performed at step S2 of FIG. 1 to identify bird objects in an image is now described with reference to FIGS. 3 and 4 and a particular example of auk species identification. While the example processing described below represents a preferred method of performing the processing of step S2, it will be readily apparent to those skilled in the art that other methods of object recognition may be used.

At a step S10, the image selected at step S1 is processed to generate a greyscale image. Referring to FIG. 4, it is shown that an original image 5 represents the image selected at step S1, while a greyscale image 6 represents the greyscale image generated at step S10. Generation of a greyscale image 6 from the selected image 5 may be by way of any appropriate method, for example by using the “rgb2gray” function in Matlab. Processing then passes to a step S11 at which an edge detection filter is applied to the greyscale image, resulting in a binary edge image 7. Edge detection may be performed by any appropriate means and in the presently described embodiment is performed using Canny edge detection. As will be well known by those skilled in the art, the Canny edge detector finds edges by identifying local maxima in pixel gradients, calculated using the derivative of a Gaussian filter. In particular, the Canny edge detector first smoothes the image by applying a Gaussian filter having a particular standard deviation (sigma). The sigma value of the Gaussian filter is a parameter of the Canny edge detector.

After smoothing the image, the Canny edge detector finds a direction for each pixel at which the greyscale intensity gradient is greatest. Gradients at each pixel in the smoothed image are first estimated in the X and Y directions by applying a suitable edge detection operator, such as the Sobel operator. The Sobel operator convolves two 3×3 kernels, one for horizontal changes (Gx) and one for vertical (Gy) with the greyscale image, where:

$$Gx = [ \begin{matrix}- 1 & 0 & + 1 \\ - 2 & 0 & + 2 \\ - 1 & 0 & + 1\end{matrix} ]$$

$$and$$

$$Gy = [ \begin{matrix}- 1 & - 2 & - 1 \\ 0 & 0 & 0 \\ + 1 & + 2 & + 1\end{matrix} ]$$

The gradient magnitudes and directions for each pixel are then determined using equations (1) and (2) respectively:

|G|=\sqrt{Gₓ²+G_{y}²} (1)

where Gₓ and G_{y} are the gradients in the x and y directions respectively

$$θ = arctan ( \frac{{G}_{y}}{{G}_{x}} ) \qquad ( 2 )$$

Each gradient direction is rounded to the nearest 45 degree angle such that each edge is considered to be either in the north-south direction (0 degrees), north-west-south-east direction (45 degrees), east-west direction (90 degrees) or the north-east-south-west direction (135 degrees).

Once the estimates of image gradients have been determined, pixels representing local maxima in the gradient image are preserved (as measured either side of the edge—e.g. for a pixel on a north-south edge, pixels to the east and west of that pixel would be used for comparison), while all other pixels are discarded so that only sharp edges remain. This step is known as non-maximum suppression. The edge pixels remaining after the non-maximum suppression are then thresholded using two thresholds, a strong edge threshold and a weak edge threshold. Edge pixels stronger than the strong edge threshold are assigned the value of ‘1’ in the binary edge image 7, while pixels with intensity gradients between the strong edge threshold and the weak edge threshold are assigned the binary value ‘1’ in the binary edge image 7 only if they are connected to a pixel with a value larger than the strong edge threshold, either directly, or via a chain of other pixels with values larger than the weak edge threshold. That is, weak edges are only present in the binary edge image 7 if they are connected to strong edges. This is known as edge tracking by hysteresis thresholding.

It has been found that the Canny edge detector is particularly useful for identifying “light” bird objects in the greyscale image 6 (i.e. those birds objects comprised of pixels having higher intensity values).

As noted above, various parameters of the Canny edge detector may be set to optimize the edge detection in dependence upon the type of object that is to be detected. It has been found that modifying two parameters of the Canny edge detector in particular, the sigma value and the strong edge threshold value, can improve the accuracy of detected edges of bird objects depicted in 2 cm spatial resolution images of birds. The images can be collected by any suitable camera. The bird objects may be on or over a water surface.

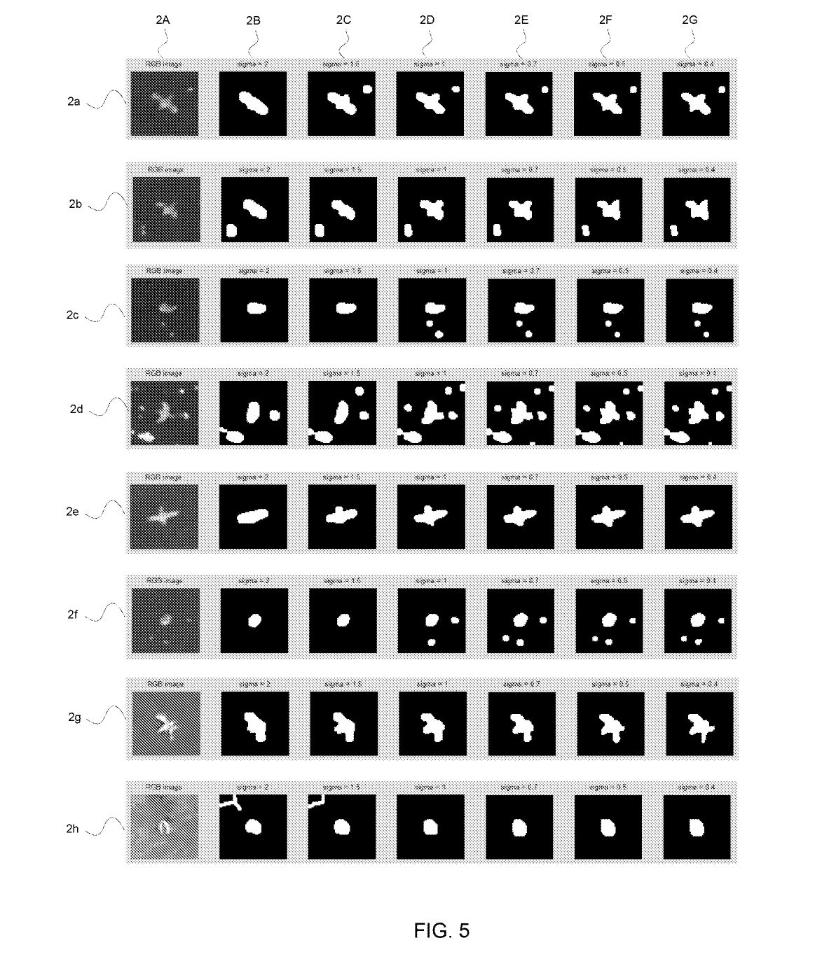

The sigma value of the Canny edge detector defines the standard deviation of the Gaussian function convolved with the greyscale image produced at step S10. The sigma value is often set to a default value of ‘2’ for general purpose edge detection applications. Referring to FIG. 5, a plurality of binary images show the effect of varying the sigma parameter for detecting the edges of images of auks using the Canny edge detector. In more detail, FIG. 5 shows a plurality of rows 2a to 2h, each row relating to a respective auk in the image data. For each row 2a to 2h, an image in a first column, 2A, shows the RGB (i.e. colour) image of the respective auk; the following six images illustrate the effect of different sigma values on the detected bird boundary. In particular, an image at a second column 2B is generated when using a sigma value of ‘2’, an image in a third column 2C is generated when using a sigma value of ‘1.5’, an image at a fourth column 2D is generated when using a sigma value of ‘1’, an image at a fifth column 2E is generated when using a sigma value of ‘0.7’, an image at a sixth column 2F is generated when using a sigma value of ‘0.5’ and an image at a seventh column 2G is generated when using a sigma value of ‘0.4’. As can be seen from FIG. 5, it has been found that a reduction in the sigma value below the default of ‘2’ leads to significant improvements in the detected outline for bird objects. This improvement continues up to a sigma value of ‘0.5’, after which further reductions in the sigma value result in no improvement of the accuracy of the detected outline for bird objects. As such, a value of 0.5 is considered to be particularly suitable for reasons of efficiency.

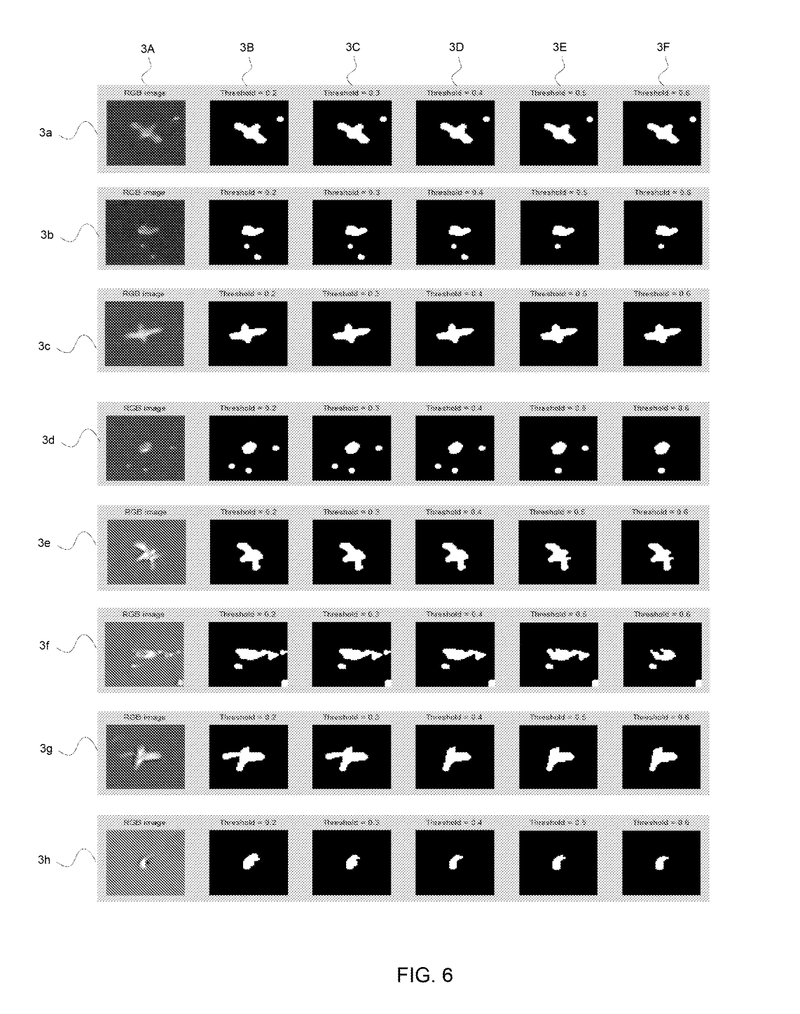

As indicated above, the strong edge threshold value is used to detect strong edges. The strong edge threshold is often set to a default value of ‘0.4’ for general purpose detection applications, while the weak edge threshold is often set to a value of ‘0.4* strong edge threshold’. Referring to FIG. 6, there is shown the effect of varying the strong edge threshold on auk object detection using the Canny edge detector. As in FIG. 5, a plurality of rows 3a to 3h each relate to a respective auk, with an image in a first column 3A showing the RGB (i.e. colour) image of the auk. For each row 3a to 3h, an image in a second column 3B is generated when using a strong edge threshold value of ‘0.2’, an image in a third column 3C is generated when using a strong edge threshold value of ‘0.3’, an image in a fourth column 3D is generated when using a strong edge threshold value of ‘0.4’, an image in a fifth column 3E is generated when using a strong edge threshold of ‘0.5’ and an image in a sixth column 3F is generated when using a strong edge threshold of ‘0.6’. As can be seen from FIG. 6, it has been found that increasing the strong edge threshold improves the accuracy of detected outlines of bird objects. This improvement continues up with a value of ‘0.5’, after which further increases in the strong threshold value result in a deterioration of the accuracy of the detected outline of bird objects. As such, a value of ‘0.5’ is considered particularly suitable.

Referring back to FIGS. 3 and 4, processing passes from step S11 at which the binary edge image 7 was generated, to a step S12, at which the binary edge image 7 is morphologically dilated twice using a predefined structuring element to ensure that the boundaries of the detected objects are continuous, resulting in a dilated image 8. As will be appreciated by those skilled in the art of object detection, dilation enlarges the boundaries of objects by connecting areas that are separated by spaces smaller than the structuring element.

Processing passes from step S12 to a step S13, at which the dilated image 8 is subjected to a fill operation to fill any holes within detected boundaries, resulting in a filled image 9. Processing then passes to a step S14, at which the filled image 9 is morphologically eroded, using the same structuring element as is used for the dilation at step S11, to reduce the size of the detected objects. The processing of step S14 results in an eroded image, referred to herein as a first binary object image 10. Morphological erosion subtracts objects smaller than the structuring element, and removes perimeter pixels from larger image objects.

It will be appreciated that any suitable structuring element may be used in the dilation of step S11 and the erosion at step S14. A structuring element of size 3 (i.e. a 3×3 kernel matrix) is often provided as a default value for general detection algorithms. It has been found, however, that increasing the size of the structuring element reduces the accuracy of detected bird boundaries, and conversely, decreasing the size of the structuring element increases the accuracy of detected bird boundaries. In particular, a structuring element of size 2 (i.e. a 2×2 matrix of ‘1’s) has been found to particularly suitable.

Morphological operations, such as dilation, apply a structuring element to an input image, creating an output image of the same size. The value of each pixel in the output image is based on a comparison of the corresponding pixel in the input image with its neighbours. Dilation adds pixels to the boundaries of objects in an image, where the number of pixels added to objects in an image depends on the size and shape of the structuring element used to process the image. By applying a structuring element comprising a two by two matrix of ones to the detected objects, the structuring element increases the size of the objects by approximately one pixel around the object boundaries, whilst retaining the original shape of the objects. In comparison, a larger structuring element, i.e. a three by three matrix of ones, would alter the shape of the object as well increasing the size of the object. Referring to FIG. 7, there is shown the effect of varying the size of the structuring element used for the dilation operation on an auk object. A first image 4A shows an RGB (i.e. colour) image of an auk object. A second image 4B shows the effect of a morphological dilation performed on the image 4A with a structuring element of size 2, a third image 4C shows the effect of a morphological dilation performed on the image 4A with a structuring element of size 3, while a fourth image 4D shows the effect of a morphological dilation performed on the image 4A with a structuring element of size 4. It can be seen from FIG. 7 that the shape of the auk object depicted in the image 4A becomes increasingly distorted with respective increases in the size of the structuring element used for the dilation operation.

Processing passes from step S14 to a step S15, at which the greyscale image 6 is thresholded using a ‘dark pixel threshold’ to output a second binary object image 11. The dark pixel threshold may be set at any appropriate value to detect “dark” bird objects (i.e. those bird objects comprised of pixels with a lower intensity in the greyscale image). For example, the dark pixel threshold may be set to be equal to 10% of the mean of the pixel values in the greyscale image generated at step S10. In more detail, the processing of step S15 assigns a pixel in the dark bird object image a value of ‘1’ (i.e. considers that pixel to be an object pixel) if it has a pixel value above the dark pixel threshold, and assigns a value of ‘0’ (i.e. considers that pixel to be background) if it has a pixel value below the dark pixel threshold. It will be appreciated that the processing of step S15 may be performed simultaneously to the processing of any or more of steps S11 to S14.

Following completion of the processing of steps S14 and S15, the first binary object image 10 and the second binary object image 11 are combined at step at a step S16 by way of a logical OR operation to provide a single complete binary object image 12.

Processing passes from step S16 to step S17 at which object area and centroid coordinates (using the image coordinate system) are extracted for each object in the binary object image. At a step S18, objects of less than a predetermined size threshold are discarded. It will be appreciated that the size threshold may be set in dependence upon the images acquired and types of birds it is desired to identify. For example, a threshold of 40 pixels has been found to be suitable for discarding objects which are too large to belong to the auk group when spatial resolution is 2 cm. It will be appreciated that a further threshold may be set to discard images which are considered to be too small to belong to the auk group

Finally, at step S19, each remaining object is added to a binary format structured matrix file to create a final binary object image 13. Preferably, the final binary object image is assigned the same filename as the image file 6 selected at step S1 of FIG. 2 for data integrity purposes.

As will be appreciated from the description above, the processing of FIG. 3 identifies bird objects in an image, discarding those objects that do not conform to certain predefined visual requirements (such as size thresholds). False positives (i.e. non-bird objects being identified as bird objects) resulting from the processing of FIG. 3 may potentially be caused by non-bird objects which nonetheless satisfy the predefined visual requirements. For example, wave crests or flotsam may lead to false positives.

To reduce the occurrence of false positives, the spectral properties of identified objects may be analysed using further bands of the electromagnetic spectrum. For example, the camera system used to acquire the survey images may be adapted to acquire information in the infra-red band. In this way, bird objects in the final binary object image generated at step S19 can be correlated with thermal hotspots identified by the camera system. A bird will emit a certain amount of heat (which will vary between in-flight and stationary birds), and will therefore have a distinctive thermal ‘signature’. An object without, or with a different, thermal signature may therefore be discarded.

Following the processing of FIG. 3, the final binary object image is used to identify particular types of birds present in the output image. An example of processing suitable for identifying types of birds is now described with reference to FIG. 7.

At a step S25, a bird object in the final binary object image is selected. At a step S26, pixels at the image coordinates of the selected bird object are extracted from the image data selected at step S1. That is, for the bird object selected at step S25, the pixels of the corresponding bird object in the image selected at step S1 are extracted. Processing then passes to a step S27 at which the extracted pixels are assigned to one of 49 equally spaced DN bins and used to create respective histograms for the red, green and blue channels. “DN” or Digital Number, is the value used to define the digital image values. Generally, these are in RGB bands, but any non-visible band can also be represented by a DN. The DN values typically run along a scale from 0 (black) to 255 (white). Histogram generation of the DN values may be performed using any appropriate method, for example Matlab's Histogram function which takes as parameters a DN data set and a number of bins. Where the camera system used to acquire the image data is adapted to capture data in spectral bands beyond the visible spectrum, histograms may also generated for the additional bands at step S27.

Processing passes from step S27 to a step S28 at which it is determined if the bird object selected at step S25 is the final bird object in the image. If it is determined that the selected bird object is not the final bird object in the image, processing returns to step S25 at which a further bird object is selected. If, on the other hand, it is determined at step S28 that the selected bird object is the final bird object (i.e. if histograms have been generated for each of the bird objects detected in the image selected at step S1 of FIG. 2), processing passes to a step S29 at which bird objects considered to be too dark or too light for automatic identification are discarded. For example, where each of the identified bird objects is an auk and it is desired to distinguish between species of auk, identified bird objects having red and/or blue channel peaks at 0 DN or 190 DN are discarded. That is, any bird object which has a majority of pixels with either red and/or blue pixels at 0 DN is considered to be too dark for automatic auk species identification, while any bird object having a majority of pixels with either red and/or blue pixels at 190 DN is considered to be too light for automatic auk species identification.

Processing passes from step S29 to a step S30 at which bird objects having an area greater than the threshold for a sitting or flying bird are discarded. Operator input is currently required to define the behaviour to be assigned to the bird object. The processing of step S30 is beneficial where artefacts in the image have been added to a bird object outline during the dilation phase of step S11. For example, variation in a surface of or glints in the sea beneath the bird, may be added to the bird outline. Discarding bird objects with an abnormally large area helps to remove bird objects unsuitable for, or which might negatively influence, automatic differentiation.

Bird objects discarded at either step S29 or step S30 are marked to indicate that they should be assessed by an operator.

Processing passes from step S30 to a step S31 at which a cluster analysis is performed, using the histogram values to partition each identified bird object into groups, with each group containing a specific type of bird. Different birds exhibit different spectral properties, those differences causing the cluster analysis performed at step S31 to automatically separate the birds into clusters depending on those spectral properties.

For example, the plumage of razorbills is generally darker than that of guillemots, and as such, razorbill objects would generally have peaks in the red and blue channels at lower DN values, than would guillemot objects. As such, for automatically differentiating between razorbills and guillemots, a k-means cluster analysis may performed on the peak blue and red bin values for all remaining bird objects at step S31. k-means cluster analysis is well known and as such is not described in detail herein. In general terms, however, a set of k “means” are selected from the bird objects, where k is the number of clusters to be generated. Each remaining bird object is then assigned to a cluster with the closest mean (in terms of Euclidean distance). The means are then updated to be the centroid of the bird objects in each cluster, and the cluster assignment is repeated. The k-means cluster analysis iterates between cluster assignment and means updating, until the assignment of bird objects to clusters no longer changes. For differentiating between razorbill and guillemot bird objects, two means would be selected, resulting in two clusters, with each bird object being assigned to one of the two clusters. It will be appreciated that in the above example, it is desirable that the image data includes only razorbill and guillemot objects. More generally, where it is desired to distinguish between two or more predetermined bird types, it is desirable that the image to be processed comprises only those birds types between which it is desired to distinguish. In this way, a suitable value of k may be selected (i.e. the number of types between which it is desired to distinguish).

Where the camera system used to acquire the image selected at step S1 is adapted to acquire images in bands of the electromagnetic spectrum outside the visible spectrum (for example, all or a portion of the infra-red band), such spectral information may also be used in the cluster analysis.

The k-means cluster analysis may be performed a number of times with different starting means.

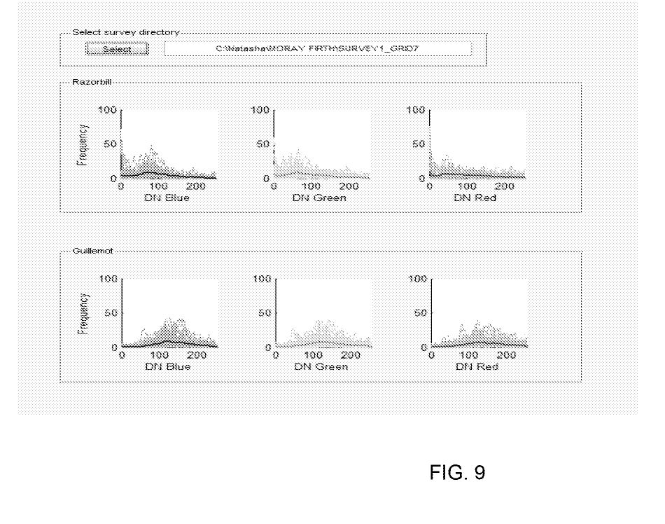

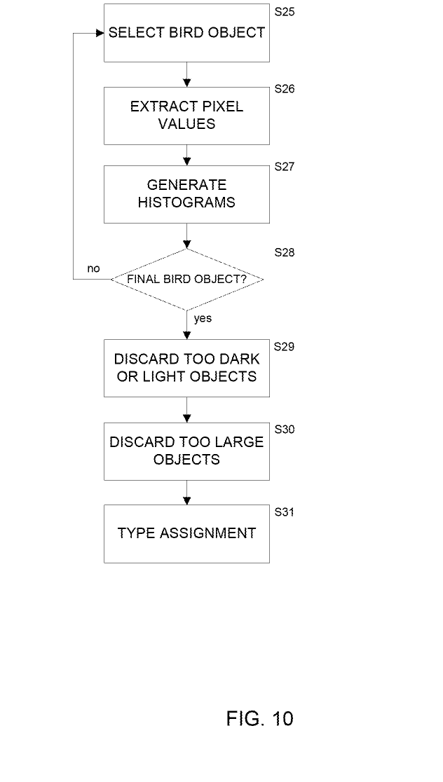

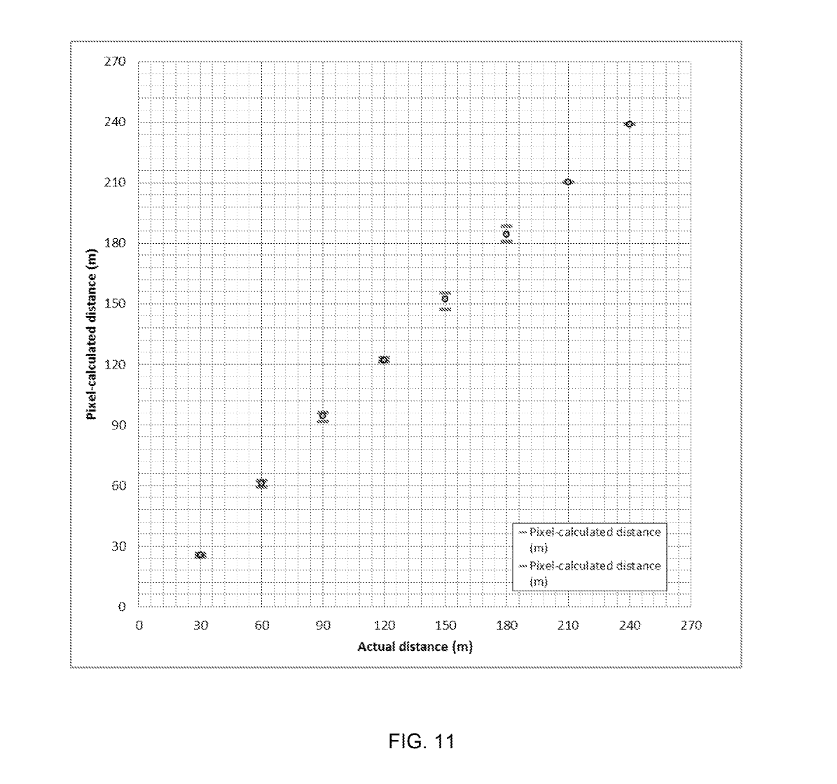

The assignment of bird objects to groups at step S31 allows for identification of types of bird depicted by the bird objects at a step S32. The identification may be performed by outputting the results of the cluster analysis (for example in the form of a scatter plot as shown in FIG. 8) onto a screen of a computer for a human operator to assess and assign a type to each cluster.

Where a human operator is to perform the final identification, additional information may be presented in addition to the output of the cluster analysis to aid identification. For example, for each cluster, for each respective colour channel, the generated histograms for each bird object may be plotted on top of each other, with a mean value plotted as a thicker line (an example of such a histogram plot is illustrated in FIG. 9). In this way, the human operator can visualise the histograms for each cluster, to determine if their assignation of type seems correct.

After the processing of FIG. 2, but before the processing of FIG. 3, it may be desirable to manually pre-process the selected image data to narrow the types of bird between which it is desired to automatically distinguish. For example, where it is desired to differentiate between species of birds, it may be desirable to manually label the bird objects to a particular family or group level. An example is described above of differentiating between razorbills and guillemots. In this case, after the bird objects have been identified by the processing of FIG. 2, it may be desirable to manually label each bird object with the family of the bird represented by that bird object so that each bird object not belonging to the auk family can be discarded. Further manual labelling may be performed until only razorbills and guillemots are present in the image data.

A number of extra tools may be provided to help the user manually label birds in the image. Tools may include, for example, an integrated library of images and text descriptions of bird species to aid in the identification process; a point value tool which outputs the multi-band pixel values for the current point marked by the mouse cursor when placed over an image; ruler tools; and an image histogram tool which allows the details of objects to be recorded (including total number of pixels, the mean pixel value and standard deviation of the pixel distribution); and a library of standard values of distributions and pixel extremes for known species.

In addition to the types of birds present in a survey area, other attributes of the observed birds may also be determined. For example, once the type of each bird object has been identified, the flying height of each bird depicted in the image data (which may be required information for the purposes of environmental impact assessment) may be calculated. In more detail, bird flight height is calculated based on a relationship between the number of pixels comprising a bird object within the image and the distance between a bird and the aircraft.

Bird flight height may be calculated based upon a reference body length or reference wingspan for the type of bird, the measured number of pixels of the imaged bird object, a known direct correlation between the distance from the camera and the pixel count, and known parameters including the sensor size and the focal length of the lens of the camera used to acquire the image data. Specifically, as the focal length of the camera lens and the altitude of the aircraft are known, the target spatial resolution (ground sample distance or GSD) can be calculated. Similarly, given an average body length or wingspan for a specific type of bird and a count of the number of pixels in a bird object, the GSD for that bird object can also be calculated. This can be used to calculate the distance of the bird object from the lens, which can then be subtracted from the altitude of the aircraft to provide a flying height of the bird object.

For example, the ground sample distance (GSD), which measures the distance between pixel centres measured on the surface of the water beneath the camera, can be calculated using formula (3):

$$G S D = \frac{p}{f} η \qquad ( 3 )$$

where p=the detector pitch of the image sensor of the camera system (i.e. the distance between detectors on the image sensor), f is the focal length of the camera system, and η is the height of the sensor of the camera system. Given the GSD and an average body length and wingspan for an observed bird-type (from published literature and measurements made on preserved specimens), it can be determined how many pixels the imaged bird should take up in the image at a distance equal to the height of the sensor. The flight height of the imaged bird can then be calculated using equation (4):

$${H}_{bird} = η - ( ( \frac{{σ}_{k}}{{σ}_{m}} ) * η ) \qquad ( 4 )$$

Where H_{bird} is the flying height of the imaged bird, η is the sensor height (as in equation (3)), σₖ is known average bird size and σₘ is bird size measured from the image.

Equation (4) holds for birds at the image centre. For birds not at the image centre, the distance of the bird from the image centre is measured and the angle from the sensor to the centre of the bird calculated. Trigonometry can be then be used to calculate the distance between the sensor altitude and the bird, from which flying height of the bird can be calculated.

FIG. 8 shows the correlation between the actual measured distance of the object from the camera (measured using a ground-based assessment) and those calculated using body length and pixel count. For each actual distance of 30 m, 60 m, 90 m, 120 m, 150 m, 180 m, 210 m, 240 m and 270 m from the camera, two pixel-calculated distance values were derived (shown as horizontal bars in FIG. 8), and an average of the two taken (shown as a circle). It can be seen that the maximum error using this technique was 8 m (at an actual distance of 180 m). However, the majority of distances calculated using body length and pixel count have been calculated to within 5 m of the actual distances.

Direction of flight of observed birds is another important parameter that is often required as part of an avian survey. Embodiments of the present invention derive direction of flight for each identified bird object automatically from a body length measurement made by the user. In more detail, when reviewing a bird object, a user selects a start of the bird object corresponding to a rear (tail) most pixel of the bird, and end point for the length measurement corresponding to the front (beak) most pixel of the bird. From these measurements, a direction of the bird depicted by the bird object is calculated using quadrant trigonometry. Such methods split an image into four quadrants by equally splitting the image vertically and horizontally. Standard trigonomic equations are used to define the direction, as a function of a Cartesian coordinate system, but each equation accounts for the central origin. The calculated flight direction is then corrected using the direction of flight (heading) of the aircraft at the point of data capture. This information is recorded at the time that the image is captured. Correction is required to transform the image coordinate system into geographic coordinates, attaching a real-world location to all the bird objects. The corrected flight direction data is stored (using a real-world coordinate system) together with the other attributes of the bird object.

All identified birds are geo-referenced to a specific location along with a compass heading of the bird in question. The collected and generated data can be exported for a single image, a directory of images or multiple directories of images and may be saved as a Comma Separated Values file, which is an open and easily transferable file format so can be used by many other third-party software packages. All metadata can be output in the same format. All identified objects are output as an image, enabling a comprehensive library of imagery for each bird type to be collected.

While the above description has been concerned with processing images of birds, it will be appreciated that many of the techniques and principles outlined above could be equally used to distinguish between other animals.

Further modifications and applications of the present invention will be readily apparent to the appropriately skilled person from the teaching herein, without departing from the scope of the appended claims.

What is claimed is:

1. A computer implemented method for distinguishing between animals depicted in one or more images, based upon one or more taxonomic groups, comprising:
receiving image data comprising a plurality of parts, each part depicting a respective animal;
determining one or more spectral properties of at least some pixels of each of said plurality of parts; and
allocating each of said plurality parts to one of a plurality of sets based on said determined spectral properties;
such that animals depicted in parts allocated to one set belong to a different taxonomic group than animals depicted in parts allocated to a different set.

2. A method according to claim 1, wherein determining one or more spectral properties comprises comparing spectral histogram data generated for said at least some pixels of each part.

3. A method according to claim 2, wherein comparing spectral histogram data comprises comparing locations of peaks in respective spectral histogram data generated for said at least some pixels of each part.

4. A method according to claim 1, wherein allocating each of said plurality of parts to one of a plurality of sets comprises applying a k-means clustering algorithm on the spectral properties of said at least some pixels of each part.

5. A method according to claim 1, further comprising:
processing said received image data to identify at least one of said parts of said image data depicting an animal.

6. A method according to claim 5, wherein said image data is colour image data and identifying a part of said image data comprises processing said image data to generate a greyscale image and identifying at least a part of said greyscale image depicting an animal.

7. A method according to claim 1, wherein identifying a part of said image data comprises applying an edge detection operation to image data to generate a first binary image.

8. A method according to claim 7, wherein said edge detection comprises convolving said image data with a Gaussian function having a standard deviation of less than 2.

9. A method according to claim 8, wherein said Gaussian function has a standard deviation of about 0.5.

10. A method according to claim 7, further comprising applying a dilation operation to said first binary image using a predetermined structuring element.

11. A method according to claim 7, further comprising applying a fill operation to said first binary image.

12. A method according to claim 7, further comprising applying an erosion operation to said first binary image.

13. A method according to claim 1, wherein identifying a part of said image data comprises applying a thresholding operation to said image data to generate a second binary image.

14. A method according to claim 13, wherein identifying a part of said image data comprises applying an edge detection operation to image data to generate a first binary image and further comprising combining said first and second binary images with a logical OR operation to generate a third binary image.

15. A method according to claim 7, wherein said edge detection comprises Canny edge detection and uses a strong edge threshold greater than about 0.4.

16. A method according to claim 15, wherein said strong edge threshold is about 0.5.

17. A method according to claim 1, further comprising:
manually labelling one or more animals in said image data with a first taxonomic group of a first taxonomic rank; and
wherein separating each of said plurality of images into sets comprises separating each of said plurality of images into sets based upon a second taxonomic group of a second taxonomic rank, said second taxonomic rank being lower than said first taxonomic rank.

18. A method according to claim 1, further comprising identifying a first taxonomic group of animals depicted in parts of said image data separated into a first set based upon a known second taxonomic group of animals depicted in parts of said image data separated into a second set; and
outputting an indication of said first taxonomic group.

19. A method according to claim 1, wherein said animals are birds.

20. A method according to claim 1, wherein said animals are birds belonging to the auk group.

21. A method according to claim 1, wherein said animals are either guillemots or razorbills.

22. A method according to claim 1, wherein said image data was acquired from a camera mounted aboard an aircraft, said camera being adapted to acquire images in a portion of the electromagnetic spectrum outside the visible spectrum.

23. A method according to claim 22, wherein said image data was acquired by a camera adapted to acquire images in an infra-red portion of the electromagnetic spectrum.

24. A method according to claim 1, wherein said image data was acquired from about 240 metres above sea level.

25. A method according to claim 19, further comprising:
selecting one of said parts depicting an animal;
identifying a third taxonomic group of said animal based on a set to which said animal has been allocated; and
determining a flight height of said animal depicted in said part based upon a known average size of said animal based upon said third taxonomic group of said animal.

26. A method according to claim 25, wherein said image data was acquired from a camera mounted aboard an aircraft, said camera being adapted to acquire images in a portion of the electromagnetic spectrum outside the visible spectrum and wherein calculating a flight height of said animal comprises:
determining a ground sample distance of said image data;
determining based on said ground sample distance an expected pixel size of an animal belonging to said third taxonomic group at a distance equal to a flight height of said aircraft; and
determining said flight height of said animal based upon a difference between said expected size and a size of the depiction of said animal in said part.

27. A method of generating image data to be used in the method of claim 1, comprising:
mounting a camera aboard an aircraft, said camera being adapted to capture images in a visible portion of the spectrum and in a non-visible portion of the spectrum;
flying said aircraft at about 240 metres above sea level; and
capturing images of animals in a space below said aircraft.

28. A computer readable medium carrying a computer program comprising computer readable instructions configured to cause a computer to carry out a method according to claim 1.

29. A computer apparatus for distinguishing between animals depicted in one or more images based on or more taxonomic groups, comprising:
a memory storing processor readable instructions; and
a processor arranged to read and execute instructions stored in said memory;
wherein said processor readable instructions comprise instructions arranged to control the computer to carry out a method according to claim 1.

30. Apparatus for distinguishing between animals depicted in one or more images based on or more taxonomic groups, comprising:
means for receiving image data comprising a plurality of parts, each part depicting a respective animal;
means for determining one or more spectral properties of at least some pixels of each of said plurality of parts;
means for allocating each of said plurality parts to one of a plurality of sets based on said determined spectral properties such that animals depicted in parts allocated to one set belong to a different taxonomic group than animals depicted in parts allocated to a different set.
